(19) United States
(12) Patent Application Publication
(10) Pub. No.: US 2019/0226585 A1
(43) Pub. Date: Jul. 25, 2019

(54) Hydrodynamic Intershaft Piston Ring Seal

(71) Applicant: General Electric Company, Schenectady, NY (US)

(72) Inventors: Kyle Robert Snow, Loveland, OH (US); Scott Wolfer, Cincinnati, OH (US); Daniel Scott Tomasic, West Chester, OH (US)

(21) Appl. No.: 15/879,535

(22) Filed: Jan. 25, 2018

(51) Int. Cl. F16J 15/34; F02C 7/28

(52) U.S. Cl. CPC F16J 15/3448; F02C 7/28

(57) ABSTRACT

Sealing assemblies and systems and their assembly methods are provided. For example, a seal assembly is provided for use between an inner shaft and an outer shaft that are rotatable about a common axis. The seal assembly comprises a first end ring having an aft face; a second end ring positioned aft of the first end ring and having a forward face; a first hydrodynamic portion defined on the aft face of the first end ring; a second hydrodynamic portion defined on the forward face of the second end ring. A seal element is disposed between the first end ring and the second end ring such that the seal element is positioned between the first hydrodynamic portion and the second hydrodynamic portion.

### FEDERALLY SPONSORED RESEARCH

This invention was made with government support under contract number FA8650-07-C-2802 of the Department of the Air Force. The government may have certain rights in the invention.

### FIELD

The present subject matter relates generally to gas turbine engines and, more particularly, to hydrodynamic sealing systems for gas turbine engines.

### BACKGROUND

Gas turbine engines typically include a rotor assembly, a compressor, and a turbine. The rotor assembly includes a fan having an array of fan blades extending radially outwardly from a rotor shaft. The rotor shaft, which transfers power and rotary motion from the turbine to both the compressor and the fan, is supported longitudinally using a plurality of bearing assemblies. Known bearing assemblies include one or more rolling elements supported within a paired race. To maintain a rotor critical speed margin, the rotor assembly is typically supported on three bearing assemblies: one thrust bearing assembly and two roller bearing assemblies. The thrust bearing assembly supports the rotor shaft and minimizes axial and radial movement thereof, while the roller bearing assemblies support radial movement of the rotor shaft.

Typically, these bearing assemblies are enclosed within a housing disposed radially around the bearing assembly. The housing forms a compartment or sump that holds a lubricant (e.g., oil) for lubricating the bearing. This lubricant may also lubricate gears and other seals. Gaps between the housing and the rotor shaft are necessary to permit rotation of the rotor shaft relative to the housing. The bearing sealing system usually includes two such gaps: one on the upstream end and another on the downstream end. In this respect, a seal disposed in each gap prevents the lubricant from escaping the compartment. Known seals include labyrinth or knife-edge seals, carbon seals, and piston ring seals.

However, the carbon seals may directly contact the moving rotor shaft, which may reduce the wear life of the seals and require dedicated cooling thereof. Further, labyrinth seals usually have more leakage compared to other seal types, such as piston ring seals. Moreover, piston ring seals also are direct contact seals, having reduced wear life and increased cooling requirements like carbon seals, and cannot withstand the demands of relatively higher pressure differentials that arise in some engine applications.

In this respect, many gas turbines now use hydrodynamic circumferential or face seals with a stationary housing, which do not contact the rotating rotor shaft at high speed, thereby providing improved wear life. Specifically, hydrodynamic carbon seals draw air into the seal, which builds up pressure such that the seal lifts off the rotating rotor shaft, thereby maintaining a gap between the moving components and the stationary components. The pressure of air drawn into the compartment prevents the lubricant from escaping. Nevertheless, the use of multiple hydrodynamic seals instead of contact seals may increase the size, weight, cost, and installation complexity of the bearing compartment sealing system.

Accordingly, a bearing compartment sealing system for a gas turbine engine that can provide improved wear life, increase pressure differential capability, and eliminate the need for dedicated seal cooling would be welcomed in the technology. In particular, an improved intershaft hydrodynamic seal assembly that provides the advantages of hydrodynamic seals without increasing the size, weight, cost, and installation complexity of the bearing compartment sealing system, such as a hydrodynamic seal assembly that provides sufficient sealing without multiple hydrodynamic seals and associated structural supports, would be beneficial.

### BRIEF DESCRIPTION

Aspects and advantages of the invention will be set forth in part in the following description, or may be obvious from the description, or may be learned through practice of the invention.

In one exemplary embodiment of the present subject matter, a seal assembly is provided for use between an inner shaft and an outer shaft that are rotatable about a common axis with a gas turbine engine. The seal assembly comprises a first end ring having an aft face and a second end ring positioned aft of the first end ring and having a forward face. The seal assembly further comprises a first hydrodynamic portion defined on the aft face of the first end ring and a second hydrodynamic portion defined on the forward face of the second end ring. A seal element is disposed between the first end ring and the second end ring such that the seal element is positioned between the first hydrodynamic portion and the second hydrodynamic portion.

In another exemplary embodiment of the present subject matter, a sealing system for a gas turbine engine having a sump region is provided. The sealing system comprises an inner shaft, an outer shaft rotatable about a common axis with the inner shaft, and a seal assembly coupled to the inner shaft and configured to seal a high pressure area from a low pressure area. The seal assembly includes a first end ring having an aft face and a second end ring positioned aft of the first end ring and having a forward face. The seal assembly also includes a first hydrodynamic portion defined on the aft face of the first end ring and a second hydrodynamic portion defined on the forward face of the second end ring. A seal element is disposed between the first end ring and the second end ring such that the seal element is positioned between the first hydrodynamic portion and the second hydrodynamic portion.

In a further exemplary embodiment of the present subject matter, a method of assembling a sealing system for a gas turbine engine is provided. The method comprises positioning an outer shaft radially outward from an inner shaft to define a gap therebetween such that the inner shaft and the outer shaft are rotatable about a common axis. The method further comprises coupling a first end ring and a second end ring to the inner shaft. The second end ring is positioned aft of the first end ring. The first end ring has an aft face and a first hydrodynamic portion defined on the aft face, and the second end ring has a forward face and a second hydrodynamic portion defined on the forward face. The method also comprises positioning a seal element between the first end ring and the second end ring such that the seal element is positioned between the first hydrodynamic portion and the second hydrodynamic portion.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a schematic cross-section view of an exemplary gas turbine engine, according to various embodiments of the present subject matter.

FIG. 2 provides a schematic, cross-sectional side view of a sump region of a core of the exemplary gas turbine engine shown in FIG. 1, illustrating a sealing system according to an exemplary embodiment of the present subject matter.

FIG. 3 provides a cross-sectional view of a seal assembly that may be used with the sealing system shown in FIG. 2 according to an exemplary embodiment of the present subject matter.

FIG. 4 provides an end view of a first end ring of the exemplary seal assembly of FIG. 3 according to an exemplary embodiment of the present subject matter.

FIG. 5A provides a close-up view of a portion of the first end ring of FIG. 4, illustrating a width of a groove of the first end ring according to an exemplary embodiment of the present subject matter.

FIG. 5B provides a cross-sectional view of a portion of the first end ring of FIG. 4, illustrating a depth of a groove of the first end ring according to an exemplary embodiment of the present subject matter.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows and “downstream” refers to the direction to which the fluid flows. Further, with respect to engine embodiments described herein, the terms “fore” and “aft” generally refer to a position in relation to an ambient air inlet and an engine exhaust nozzle of the engine.

The exemplary apparatus and methods described herein overcome at least some disadvantages of known sealing systems for use in a gas turbine engine. Moreover, the sealing systems and methods described herein enable sealing between co-rotating or counter-rotating shafts in a turbine engine. More specifically, the sealing system described herein includes an inner shaft, an outer shaft, and a seal assembly coupled between the inner shaft and the outer shaft. The seal assembly includes a pair of end rings that each include a hydrodynamic pad. A seal element is disposed between the end rings and, more particularly, between the hydrodynamic pads. The seal assembly also includes a spacer ring extending from the first end ring to the second end ring and spaced radially inward of the seal element.

Advantages of the systems and methods described herein include the ability to reduce the amount of leakage between the inner shaft and the outer shaft as compared to conventional labyrinth seals. Such a reduction in leakage under the same or similar high pressure differential results in less being bled off compressor, resulting in a higher efficiency of the engine. Additionally, the above described intershaft sealing system has a longer service lifetime as compared to conventional piston ring seals, resulting in a reduction in operating and maintenance costs for the engine. Another advantage is a higher delta pressure capability, or higher pressure differential capability, compared to conventional piston ring seals. Moreover, direct runner oil cooling can be eliminated in the sealing system described herein, which advantageously reduces the oil flow demand on a lubrication system of the gas turbine engine, and the non-contacting nature of the sealing system reduces heat rejection to the lubrication system, thereby reducing demand on an engine thermal management system of the gas turbine engine. Further, the intershaft sealing system described herein provides sufficient sealing without the use of multiple hydrodynamic seals individually mounted to a stationary structure, which allows the foregoing advantages without unduly increasing the size, weight, cost, and installation complexity of the sealing system.

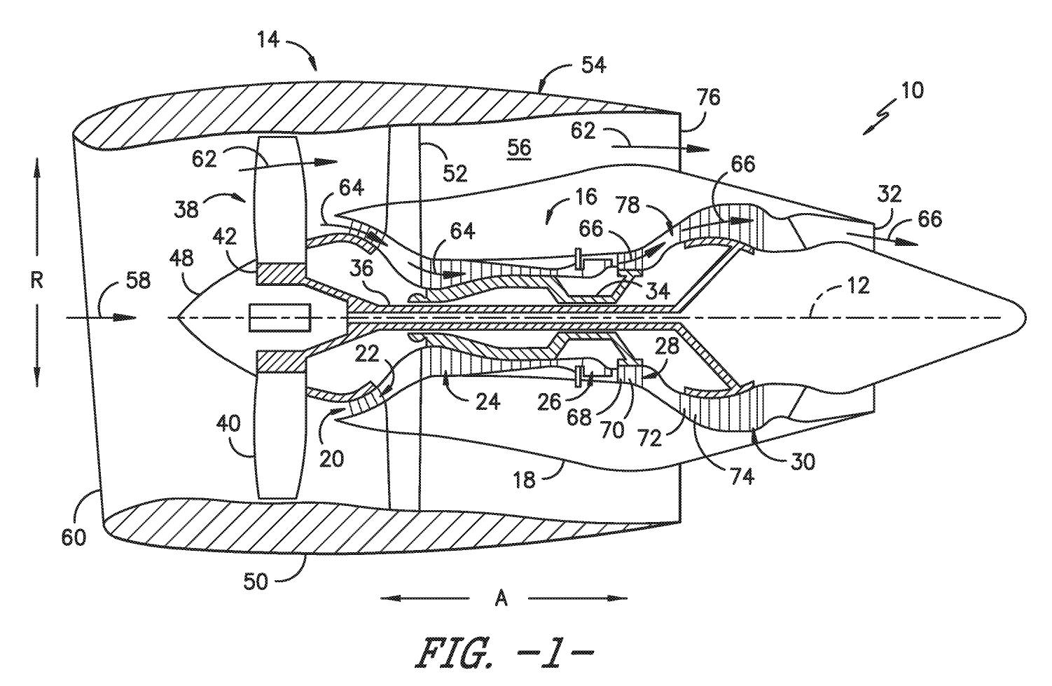

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine 10, referred to herein as “turbofan engine 10.” As shown in FIG. 1, the turbofan engine 10 defines an axial direction A (extending parallel to a longitudinal centerline 12 provided for reference) and a radial direction R. In general, the turbofan 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22. In other embodiments of turbofan engine 10, additional spools may be provided such that engine 10 may be described as a multi-spool engine.

For the depicted embodiment, fan section 14 includes a fan 38 having a plurality of fan blades 40 coupled to a disk 42 in a spaced apart manner. As depicted, fan blades 40 extend outward from disk 42 generally along the radial direction R. The fan blades 40 and disk 42 are together rotatable about the longitudinal axis 12 by LP shaft 36. In some embodiments, a power gear box having a plurality of gears may be included for stepping down the rotational speed of the LP shaft 36 to a more efficient rotational fan speed.

Referring still to the exemplary embodiment of FIG. 1, disk 42 is covered by rotatable front nacelle 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. It should be appreciated that nacelle 50 may be configured to be supported relative to the core turbine engine 16 by a plurality of circumferentially-spaced outlet guide vanes 52. Moreover, a downstream section 54 of the nacelle 50 may extend over an outer portion of the core turbine engine 16 so as to define a bypass airflow passage 56 therebetween.

During operation of the turbofan engine 10, a volume of air 58 enters turbofan 10 through an associated inlet 60 of the nacelle 50 and/or fan section 14. As the volume of air 58 passes across fan blades 40, a first portion of the air 58 as indicated by arrows 62 is directed or routed into the bypass airflow passage 56 and a second portion of the air 58 as indicated by arrows 64 is directed or routed into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and/or rotation of the fan 38.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the turbofan 10, also providing propulsive thrust. The HP turbine 28, the LP turbine 30, and the jet exhaust nozzle section 32 at least partially define a hot gas path 78 for routing the combustion gases 66 through the core turbine engine 16.

It will be appreciated that, although described with respect to turbofan 10 having core turbine engine 16, the present subject matter may be applicable to other types of turbomachinery. For example, the present subject matter may be suitable for use with or in turboprops, turboshafts, turbojets, industrial and marine gas turbine engines, and/or auxiliary power units.

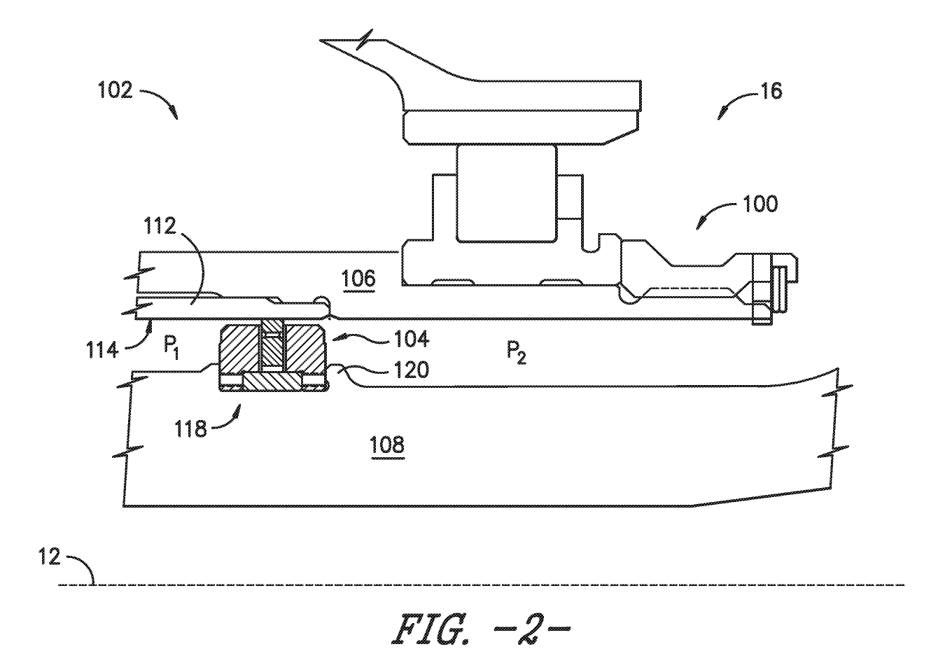

FIG. 2 provides a schematic, cross-sectional side view of a sump region 100 of the core 16 of gas turbine engine 10 (shown in FIG. 1), illustrating an exemplary sealing system 102 including a seal assembly 104. As shown in FIG. 2, the sealing system 102 seals a higher pressure area P1 on a forward side of the seal assembly 104 from a lower pressure area P2 on an aft side of the seal assembly 104. In the exemplary embodiment, the sealing system 102 includes an outer shaft 106 and an inner shaft 108 that rotate in either a counter-rotational or co-rotational fashion about the longitudinal axis 12. In the depicted embodiment, the outer shaft 106 includes a seal runner 112 positioned radially outward from the seal assembly 104 and having an inner surface 114 that faces the seal assembly 104. In other embodiments, the seal runner 112 may be omitted or may be integral with the outer shaft 106.

Further, the inner shaft 108 forms a recess or step 118 that receives the seal assembly 104. Alternatively, or in addition, the inner shaft 108 includes a retention feature 120 that retains the seal assembly in an axial position. In the exemplary embodiment, the retention feature 120 includes at least one of a mechanical stop integral with the inner shaft 108 or a distinct locking ring coupled to the inner shaft 108. Generally, the retention feature 120 is any feature that enables operation of the seal assembly 104 as described herein.

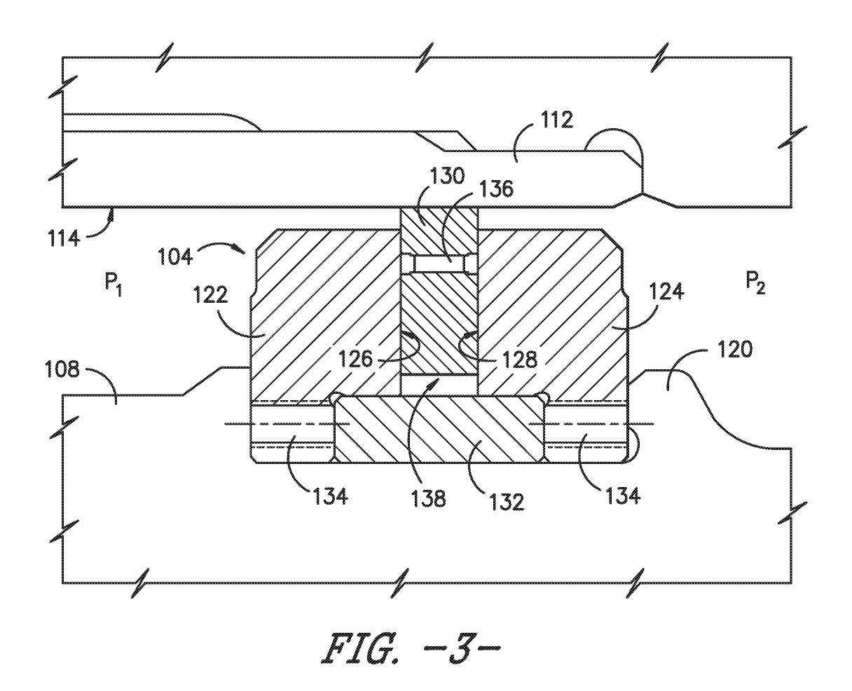

FIG. 3 is a cross-sectional view of the seal assembly 104 that may be used with the sealing system 102 shown in FIG. 2. In the exemplary embodiment, the seal assembly 104 seals a higher pressure area P1 on a forward side of seal assembly 104 from a lower pressure area P2 on an aft side of seal assembly 104 and includes a first or forward end ring 122, a second or aft end ring 124, a first hydrodynamic portion 126, a second hydrodynamic portion 128, a seal element 130, and a spacer ring 132. One or more anti-rotation pins 134 also may be used in the seal assembly 104, but other anti-rotation means may be used as well.

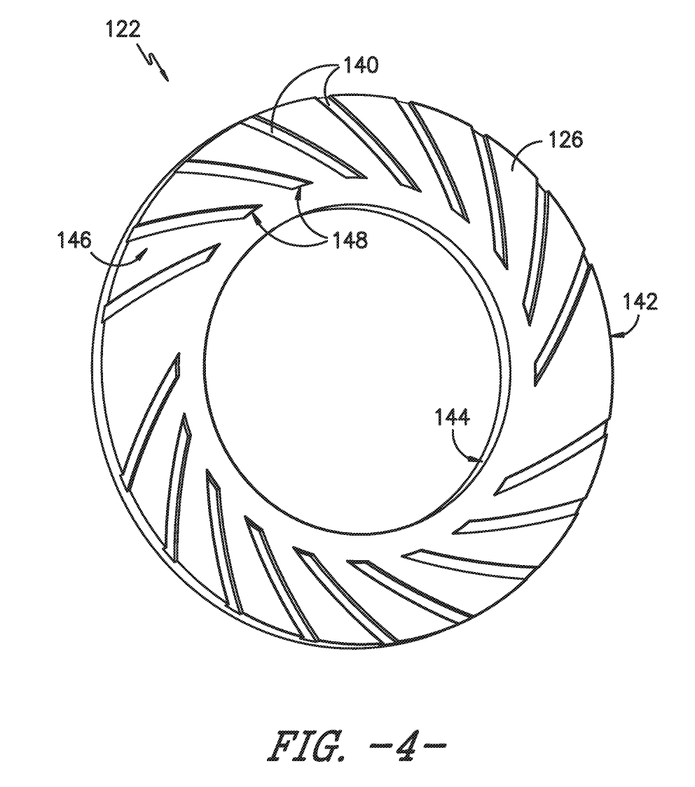

As illustrated in FIG. 3, the first end ring 122 has an aft face into which a plurality of grooves 140 (FIG. 4) are machined or otherwise defined to form the first hydrodynamic portion 126, and the second end ring 124 has a forward face into which a plurality of grooves 140 are machined or otherwise defined to form the second hydrodynamic portion 128. The second end ring 124 is positioned aft of the first end ring 122 such that the aft face and first hydrodynamic portion 126 of the first end ring 122 faces the forward face and second hydrodynamic portion 128 of the second end ring 124.

In other embodiments, the hydrodynamic portions 126, 128 may be hydrodynamic pads that are affixed to the first end ring aft face and the second end ring forward face, respectively. In such embodiments, the first hydrodynamic portion 126 is a pad disposed on the aft face of the first end ring 122, and the second hydrodynamic portion 128 is a pad disposed on the forward face of the second end ring 124. The hydrodynamic pads 126, 128 generally may be coextensive with each of the aft face and the forward face, respectively. In some embodiments, a plurality of first hydrodynamic pads 126 or pad segments may be disposed on the aft face of the first end ring 122 such that the plurality of pads 126, rather than a single pad 126, is coextensive with the first end ring aft face. For example, the first hydrodynamic pad 126 may be circumferentially split into multiple segments that cooperatively form the first hydrodynamic pad 126. Similarly, in some embodiments, a plurality of second hydrodynamic pads 128 or pad segments may be disposed on the forward face of the second end ring 124 such that the plurality of pads 128, rather than a single pad 128, is coextensive with the second end ring forward face. However, the first and second hydrodynamic pads 126, 128 need not be coextensive with their respective end ring faces, and in other embodiments, circumferential gaps may be formed between pad segments forming the first hydrodynamic pad 126 and pad segments forming the second hydrodynamic pad 128. Further, it will be understood that the hydrodynamic pads 126, 128 may be attached to the respective end ring face using any suitable attachment means. For example, the hydrodynamic pads 126, 128 may be attached to their respective end ring 122, 124 using mechanical fasteners, or the hydrodynamic pads 126, 128 may be bonded or otherwise adhered to their respective end ring 122, 124. Other attachment means may be used as well.

The seal element 130 is disposed between the first end ring 122 and the second end ring 124 such that the seal element 130 is positioned between the first hydrodynamic portion 126 and the second hydrodynamic portion 128. As depicted in FIG. 3, the seal element 130 extends radially beyond the first end ring 122 and the second end ring 124 such that an outer edge 131 of the seal element 130 is adjacent the seal runner 112. In some embodiments, the outer edge 131 contacts the inner surface 114 of seal runner 112 and rides with the outer shaft 106. In other embodiments, the seal runner 112 may be omitted, such that the outer edge 131 contacts and rides with an inner surface of the outer shaft 106. Further, the spacer ring 132 is disposed radially inward of the seal element 130, and a space or gap 138 is defined between the seal element 130 and the spacer ring 132. The spacer ring 132 extends from the first end ring 122 to the second end ring 124 and a clamp load is applied to the first and second end rings 122, 124 such that the spacer ring 132 maintains the first and second end rings 122, 124 in a relatively fixed axial position with respect to one another. That is, the spacer ring 132 helps ensure a relatively fixed spacing between the first end ring 122 and the second end ring 124 such that the seal element 130 is not pinched between the end rings 122, 124. In other embodiments, the spacer ring 132 may be integral with either the first end ring 122 or the second end ring 124, rather than a separate component from both end rings 122, 124.

The hydrodynamic portions 126, 128 are non-contact seals, which allow no contact between the stationary and moving components, or the co-rotating or counter-rotating components, when operating at high speed. Non-contact seals typically have a longer service life than contact seals. As further described herein with respect to FIG. 4, each of the first hydrodynamic portion 126 and the second hydrodynamic portion 128 is similarly configured. Each portion 126, 128 includes one or more grooves 140 defined therein. Air from the sump region 100 flows through the grooves 140 toward the gap 138, thereby creating an air film between the respective hydrodynamic portion 126, 128 and the seal element 130. Accordingly, the seal element 130 is free to float between the first end ring 122 and the second end ring 124. Further, because the seal element 130 is positioned between the hydrodynamic portion 126, 128, the seal element 130 is positioned such that it does not contact the first end ring 122 or the second end ring 124 due to the hydrodynamic force provided by the hydrodynamic portions 126, 128.

FIG. 4 provides an end view of the first end ring 122, illustrating the first hydrodynamic portion 126. Although not depicted, it will be appreciated that the second hydrodynamic portion 128 may be configured substantially similarly to the illustrated first hydrodynamic portion 126. As previously described and as illustrated in FIG. 4, the first hydrodynamic portion includes grooves 140 (e.g., spiral grooves) that extend from an outer side 142 toward an inner side 144 of the first end ring 122. More particularly, the grooves 140 are defined in a sealing face 146 of the first hydrodynamic portion 126. As will be appreciated, the grooves 140 may be recesses formed in the sealing face 146 such that the grooves 140 extend toward, but not all the way to, the inner diameter 144 of the sealing face 146. Rather, each groove 140 has a dam portion 148 and, as stated, the depicted grooves 140 are spiral grooves, such that the end of each groove 140 at the dam portion 148 is defined at a different circumferential position than the end of the groove 140 at the outer side 142. As such, air or other gas may enter the grooves 140 from the outer side 142 during operation of the engine 10 and flow through the grooves 140, accelerating along the curvature of the grooves 140 toward the dam portion 148 of each groove 140, and finally impinging against the dam portion 148, thus creating a dynamic pressure rise so as to provide a hydrodynamic separation force. In this manner, the grooves 140 may enable the generation of additional pressure toward the inner side 144 of the first hydrodynamic portion 126.

Further, as previously stated, it will be understood that, although not illustrated in the figures, the second hydrodynamic portion 128 may include grooves 140 similar to the grooves 140 depicted with respect to the first hydrodynamic portion 126, such that air flowing through the grooves 140 of the second hydrodynamic portion 128 creates a dynamic pressure rise providing a hydrodynamic separation force. As described above, the hydrodynamic separation force from the hydrodynamic portions 126, 128 allows the seal element 130 to float between the end rings 122, 124 while providing a seal between the higher pressure area P1 and the lower pressure area P2. Accordingly, the seal assembly 104 is a non-contact seal assembly.

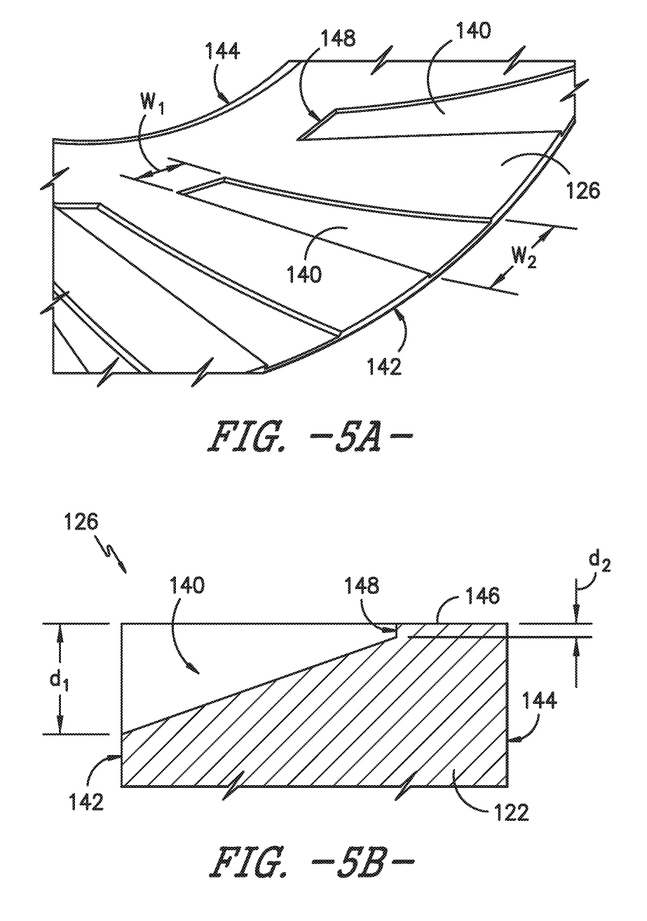

Further, as depicted in FIGS. 5A and 5B, in some embodiments, each groove 140 has a width w that diminishes from a first, larger width w₁ at the outer side 142 to a second, smaller width w₂ at the dam portion 148, and a depth d that diminishes from a first, deeper depth d₁ at the outer side 142 to a second, shallower depth d₂ at the dam portion 148. Such tapered and ramped grooves 140 may help generate a required hydrodynamic force for providing a non-contact seal. Moreover, the grooves 140 need not be spiral grooves, e.g., the end of each groove 140 at the dam portion 148 may be defined at the same circumferential position as the end of the groove 140 at the outer side 142. It will be appreciated that the grooves 140 may have any suitable geometry or configuration for generating hydrodynamic lift, e.g., the grooves 140 may be stepped grooves, parallel linear grooves, or any other suitable type of grooves.

Referring back to FIG. 3, the seal element 130 defines at least one hole 136 therethrough. The hole(s) 136 allow some leakage between the higher and lower pressure areas P1, P2 to help balance the pressure on the seal element 130 between the upstream, higher pressure area P1 and the downstream, lower pressure area P2, which contributes to a reduction in force on the seal element 130. Bleeding off some pressure through leakage through the hole(s) 136 may help the seal element 130 float between the end rings 122, 124, i.e., the leakage through hole(s) 136 allows the seal element 130 to avoid contact with the end rings 122, 124. It will be appreciated that any number of holes 136 may be defined through the seal element 130 to balance the pressure and minimize the force on the seal element 130.

In an exemplary embodiment, the seal element 130 may be formed from a non-metallic carbon material. Additionally, the first end ring 122, second end ring 124, and spacer ring 132 all may be formed from the same material. More specifically, the end rings 122, 124 and spacer ring 132 may be formed from the same material such that they have similar coefficients of thermal expansion to enable the end rings 122, 124 and spacer ring 132 to expand and contract at similar rates. In an exemplary embodiment, the end rings 122, 124 and spacer ring 132 are formed from nickel-chromium superalloys containing carbon. Alternatively, the end rings 122, 124 and spacer ring 132 may be formed from any material that facilitates operation of seal assembly 104 as described herein.

An exemplary method of assembling the sealing system 102 may include positioning the outer shaft 106 radially outward from the inner shaft 108, such that the inner shaft 108 and the outer shaft 106 are rotatable about a common axis, e.g., longitudinal axis 12 of engine 10. The method includes coupling the first end ring 122 and the second end ring 124 to the inner shaft 108. The second end ring 124 is positioned aft of the first end ring 122, such that the first hydrodynamic portion 126 defined on the aft face of the first end ring 122 faces the second hydrodynamic portion 128 defined on the forward face of the second end ring 124. The method further includes positioning the seal element 130 between the first end ring 122 and the second end ring 124 such that the seal element 130 is positioned between the first hydrodynamic portion 126 and the second hydrodynamic portion 128. The assembly method also includes inserting the spacer ring 132 radially inward of the seal element 130, between the first end ring 122 and the second end ring 124 such that the spacer ring 132 extends from the first end ring 122 to the second end ring 124, and applying a clamp load to the first and second end rings 122, 124 such that the spacer ring 132 maintains the first and second end rings 122, 124 in a relatively fixed axial position with respect to one another. As described herein, when positioned between the first and second hydrodynamic portions 126, 128, the seal element 130 is positioned such that the seal element 130 does not contact the first end ring 122 and does not contact the second end ring 124 but, rather, is free to float between the end rings 122, 124 such that the seal assembly 104 of the sealing system 102 is a non-contact seal assembly.

Additional or alternative steps to the foregoing exemplary method may occur to those of ordinary skill in the art based on the various embodiments described herein. For example, as previously described, the spacer ring 132 may not be a separate component but may be formed with either the first end ring 122 or the second end ring 124. For such embodiments, the assembly method would omit the step of inserting the spacer ring 132. As another example, in some embodiments, the hydrodynamic portions 126, 128 may be pads disposed on the first end ring 122 and second end ring 124, respectively, such that the assembly method includes the steps of disposing the first hydrodynamic pad 126 on the aft face of the first end ring 122 and disposing the second hydrodynamic pad 128 on the forward face of the second end ring 124. Other variations of the assembly method also may possible or required by the alternative embodiments described herein.

The sealing system 102 has advantages over known sealing systems. Unlike many known sealing arrangements, the sealing system 102 is a non-contact sealing arrangement. The reduced friction associated with non-contact sealing results in longer service life, lower maintenance and repair costs, and greater time on wing (TOW) than known contact sealing arrangements. Further, the hydrodynamic intershaft sealing system 102 described herein allows for the reduced leakage of a piston ring seal compared to a labyrinth seal, thus providing a performance benefit compared to labyrinth seals. However, the sealing system 102 also allows for higher delta pressure capability compared to piston ring seals, while also providing the non-contact advantages described above compared to piston ring seals, which are contacting seals. Moreover, direct runner oil cooling can be eliminated, which reduces the oil flow demand of the lubrication system, and the non-contacting nature of the hydrodynamic sealing system 102 reduces heat rejection to the lubrication system, which reduces demand on the engine thermal management system. Of course, other advantages and benefits also may be provided by the apparatus and methods described herein.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A seal assembly for use between an inner shaft and an outer shaft rotatable about a common axis with a gas turbine engine, the seal assembly comprising:
a first end ring having an aft face;
a second end ring positioned aft of the first end ring and having a forward face;
a first hydrodynamic portion defined on the aft face of the first end ring;
a second hydrodynamic portion defined on the forward face of the second end ring; and
a seal element disposed between the first end ring and the second end ring such that the seal element is positioned between the first hydrodynamic portion and the second hydrodynamic portion.

2. The seal assembly of claim 1, wherein a spacer ring is disposed radially inward of the seal element, the spacer ring extending from the first end ring to the second end ring and a clamp load applied to the first and second end rings such that the spacer ring maintains the first and second end rings in a relatively fixed axial position with respect to one another.

3. The seal assembly of claim 2, wherein a gap is defined between the seal element and the spacer ring.

4. The seal assembly of claim 1, wherein the seal element is free to float between the first end ring and the second end ring.

5. The seal assembly of claim 1, wherein a plurality of first grooves is defined in the first hydrodynamic portion, each first groove tapering from a first width at an outer side of the first hydrodynamic portion to a second width at a dam portion of the first groove, each first groove ramping from a first depth at the outer side of the first hydrodynamic portion to a second depth at the dam portion of the first groove, and wherein a plurality of second grooves is defined in the second hydrodynamic portion, each second groove tapering from a first width at an outer side of the second hydrodynamic portion to a second width at a dam portion of the second groove, each second groove ramping from a first depth at the outer side of the second hydrodynamic portion to a second depth at the dam portion of the second groove.

6. The seal assembly of claim 1, wherein at least one hole is defined through the seal element.

7. The seal assembly of claim 1, wherein the seal element extends radially beyond the first end ring and the second end ring.

8. A sealing system for a gas turbine engine having a sump region, the sealing system comprising:
an inner shaft;
an outer shaft rotatable about a common axis with the inner shaft; and
a seal assembly coupled to the inner shaft and configured to seal a high pressure area from a low pressure area, the seal assembly including
a first end ring having an aft face,
a second end ring positioned aft of the first end ring and having a forward face,
a first hydrodynamic portion defined on the aft face of the first end ring,
a second hydrodynamic portion defined on the forward face of the second end ring, and
a seal element disposed between the first end ring and the second end ring such that the seal element is positioned between the first hydrodynamic portion and the second hydrodynamic portion.

9. The sealing system of claim 8, wherein the first hydrodynamic portion comprises a plurality of grooves.

10. The sealing system of claim 8, wherein the second hydrodynamic portion comprises a plurality of grooves.

11. The sealing system of claim 8, wherein a spacer ring is disposed radially inward of the seal element, the spacer ring extending from the first end ring to the second end ring and a clamp load applied to the first and second end rings such that the spacer ring maintains the first and second end rings in a relatively fixed axial position with respect to one another.

12. The sealing system of claim 11, wherein a gap is defined between the seal element and the spacer ring.

13. The sealing system of claim 8, wherein the seal element is free to float between the first end ring and the second end ring.

14. The sealing system of claim 8, wherein the seal element is positioned such that the seal element does not contact the first end ring and does not contact the second end ring.

15. The sealing system of claim 8, wherein the first hydrodynamic portion comprises a plurality of first spiral grooves and the second hydrodynamic portion comprises a plurality of second spiral grooves.

16. The sealing system of claim 8, wherein at least one hole is defined through the seal element.

17. The sealing system of claim 8, wherein the seal element extends radially beyond the first end ring and the second end ring.

18. A method of assembling a sealing system for a gas turbine engine, the method comprising:
positioning an outer shaft radially outward from an inner shaft to define a gap therebetween such that the inner shaft and the outer shaft are rotatable about a common axis;
coupling a first end ring and a second end ring to the inner shaft, the second end ring positioned aft of the first end ring, the first end ring having an aft face and a first hydrodynamic portion defined on the aft face, the second end ring having a forward face and a second hydrodynamic portion defined on the forward face; and
positioning a seal element between the first end ring and the second end ring such that the seal element is positioned between the first hydrodynamic portion and the second hydrodynamic portion.

19. The method of claim 18, further comprising:
inserting a spacer ring radially inward of the seal element between the first end ring and the second end ring such that the spacer ring extends from the first end ring to the second end ring; and
applying a clamp load to the first and second end rings such that the spacer ring maintains the first and second end rings in a relatively fixed axial position with respect to one another.

20. The method of claim 18, wherein the seal element is positioned such that the seal element does not contact the first end ring and does not contact the second end ring.
